(19) United States
(12) Patent Application Publication
(10) Pub. No.: US 2022/0098409 A1
(43) Pub. Date: Mar. 31, 2022

(54) ELECTRICALLY INSULATING AND THERMALLY CONDUCTIVE POLYMER COMPOSITIONS

(71) Applicant: DUPONT POLYMERS, INC., Wilmington, DE (US)

(72) Inventor: Takashi Hirahara, Tochigi (JP)

(21) Appl. No.: 17/421,834

(22) PCT Filed: Jan. 10, 2020
(86) PCT No.: PCT/US2020/013107

§ 371 Date: Jul. 9, 2021

Related U.S. Application Data
(60) Provisional application No. 62/791,181, filed on Jan. 11, 2019.

(51) Int. Cl. C08L 77/10; C08K 3/04; C08K 9/02; C08K 3/26

(52) U.S. Cl. CPC C08L 77/10; C08K 3/042; C08K 2201/005; C08K 3/26; C08K 2003/267; C08K 9/02

(57) ABSTRACT

A polymer composition used for a thermally conductive, electrically insulating component is provided. The polymer composition contains three ingredients, (a) a polymer, (b) a coated graphite particle, (c) an inorganic filler, and optionally (d) additional ingredients. Preferably, the graphite particle is partially coated with magnesium carbonate. An article formed from the polymer composition may achieve higher thermal conductivity and excellent volume resistivity as well as high flowability that can lead to good moldability. The polymer composition may also show low density which can contribute to light-weighting of various applications.

### CROSS-REFERENCE TO RELATED APPLICATION

This application claims priority under 35 U.S.C. § 365 to U.S. Provisional Application No. 62/791,181, filed on Jan. 11, 2019, which is incorporated herein by reference in its entirety.

### FIELD OF THE INVENTION

The present invention relates to polymer compositions used in the manufacture of thermally conductive, electrically insulating components. Such components can be used to manufacture articles such as electronic devices.

### BACKGROUND OF THE INVENTION

Several patents and publications are cited in this description in order to more fully describe the state of the art to which this invention pertains. The entire disclosure of each of these patents and publications is incorporated by reference herein.

Electronic devices such as light emitting diodes (LEDs), integrated circuits (ICs), power electronics, displays and photovoltaics frequently encounter thermal issues during normal operation which can adversely affect the performance and the operating lifetime of these devices.

To avoid these problems, heat generated by electronic components inside electronic devices can be dissipated by using thermally conductive materials or by using heat sinks. Normally, electronic devices are covered or encapsulated by housings and thermally conductive routes or pathways are built between the electronic devices and the heat sinks or housings. In some cases, housings of electronic devices can also be heat sinks.

It is important to avoid electrical shorts between the electrical source and the device or component. Typically, electrically insulating materials are used for the manufacture of housings for electronic devices or articles. Polymeric materials are commonly used as electrically insulating materials for the preparation of housings. Although polymeric materials are good electrically insulating materials, their poor thermally conductivity is a barrier to their use as a thermal management component of electronic devices. Thermally conductive fillers are typically added to polymeric materials to increase their thermal conductivity.

Graphite is a good thermally conductive filler, but it is electrically conductive and therefore unsuitable. PCT Intl. Patent Appln. Publn. No. WO2015/031573A describes a thermally conductive, electrically insulating polymer composition comprising carbon particles coated by materials such as polymers or metal salts. Japanese Patent Appln. No. JP2015178543A describes a graphite coated with magnesium carbonate. There remains a need, however, for thermally conductive, electrically insulating fillers having an adequate balance of properties for practical use, especially for compounding and injection molding processes where the polymer compositions are subjected to high shear forces.

### SUMMARY OF THE INVENTION

Provided herein are polymer compositions comprising: (a) at least one polymer, (b) a coated graphite particle, (c) at least one inorganic filler, and optionally (d) at least one additional ingredient. Such polymer compositions can be used to prepare thermally conductive, electrically insulating components that exhibit desirable thermal conductivity. Such polymer compositions can also be easily injection molded to prepare resin components for use in the manufacture of articles such as electronic devices that exhibit desirable thermal conductivity as well as appropriate electrical insulating properties.

Further provided are polymer compositions comprising (a) at least one polymer, (b) a coated graphite particle, in which at least 50 percent of the surface of the graphite particle is covered or encapsulated by magnesium carbonate, (c) at least one inorganic filler, and optionally (d) at least one additional ingredient.

Yet further provided are articles comprising polymer compositions which in turn comprise: (a) at least one polymer, (b) a coated graphite particle, (c) at least one inorganic filler, and optionally (d) at least one additional ingredient.

### DETAILED DESCRIPTION OF THE INVENTION

The polymer compositions described herein comprise at least three components: (a) a polymer, (b) a coated graphite particle, in which at least a part of the surface of the graphite particle is covered by at least one metal compound, preferably magnesium carbonate, (c) an inorganic filler, and optionally (d) additional ingredients.

### Polymer (a)

Suitable polymers (a) for use in the polymer compositions include thermoplastic polymers, thermoset polymers and combinations of two or more polymers, such as two or more thermoset polymers, two or more thermoplastic polymers, or two or more polymers including at least one thermoplastic polymer and at least one thermoset polymer. Examples of thermoplastic polymers include polycarbonates, polyolefins such as polyethylene and polypropylene, polyacetals, polyamides such as aromatic polyamides and semi-aromatic polyamides, polyesters, polysulfones, polyarylene sulfides, liquid crystal polymers such as aromatic polyesters, polyphenylene oxides, polyarylates, polyetheretherketones (PEEK), polyetherketoneketones (PEKK), syndiotactic polystyrenes, thermoplastic vulcanizates (TPV), and mixtures thereof. Preferred thermoplastic polymers include polycarbonates, polyolefins, polyarylene sulfide, polyacetals, polyamides, and polyesters. Polyamides are more preferred.

Examples of thermoset polymers include epoxy, polyurethane, vulcanized rubber, phenol-formaldehyde resins, unsaturated thermosetting polyester resins, and polyimide resins.

When the thermoplastic polymer is a polyester, the polyester is preferably selected from the group consisting of polyesters derived from one or more dicarboxylic acids and one or more diols having two or more carbon atoms, copolyester thermoplastic elastomers, and mixtures thereof. Examples of dicarboxylic acids include one or more of terephthalic acid, isophthalic acid, and 2,6-naphthalene dicarboxylic acid. Up to 20 mole percent of aliphatic dicarboxylic acids may be used to form the polyester. Suitable acids include one or more of sebacic acid, adipic acid, azelaic acid, dodecanedioic acid, and 1,4-cyclohexanedicarboxylic acid. The diol component is selected from one or more of HO(CH₂)ₙOH;
1,4-cyclohexanedimethanol; HO(CH₂CH₂O)ₘCH₂CH₂OH; and
HO(CH₂CH₂CH₂CH₂O)_{z}CH₂CH₂CH₂CH₂OH, wherein n is an integer of about 3 to about 10, m is an integer of about 1 to about 4, and z is an integer of about 7 to about 40. Examples of suitable diols include ethylene glycol; 1,3-trimethylene glycol; 1,4-tetramethylene glycol; 1,6-hexamethylene glycol; 1,8-octamethylene glycol; 1,10-decamethylene glycol; 1,3-propylene glycol; and 1,4-butylene glycol. Preferably, the polyesters are selected from poly(trimethylene terephthalate) (PTT), poly(1,4-butylene terephthalate) (PBT), poly(ethylene 2,6-naphthoate) (PEN), poly(1,4-butylene 2,6-naphthalate) (PBN), poly(1,4-cyclohexyldimethylene terephthalate) (PCT), poly(ethylene terephthalate) (PET), and copolymers and combinations of two or more suitable polyesters.

Suitable polyamides for use in the polymer compositions include, without limitation, condensation products of one or more dicarboxylic acids and one or more diamines, or condensation products of one or more aminocarboxylic acids, or ring-opening polymerization products of one or more cyclic lactams. The polyamides are selected from aliphatic polyamides, aromatic polyamides, semi-aromatic polyamides and mixtures thereof. The term “semi-aromatic” describes polyamides that comprise at least some aromatic carboxylic acid monomer(s) and aliphatic diamine monomer(s), in comparison with “aliphatic” which describes polyamides consisting of or consisting essentially of aliphatic carboxylic acid monomer(s) and aliphatic diamine monomer(s).

Aliphatic polyamides are formed from aliphatic and alicyclic monomers such as diamines, dicarboxylic acids, lactams, aminocarboxylic acids, and their reactive equivalents. Suitable lactams include caprolactam and laurolactam. Carboxylic acid monomers useful in the preparation of fully aliphatic polyamide resins include, but are not limited to, aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14), and combinations of two or more aliphatic carboxylic acids. Useful diamines include those having four or more carbon atoms, including, but not limited to, tetramethylene diamine, hexamethylene diamine, octamethylene diamine, decamethylene diamine, 2-methylpentamethylene diamine, 2-ethyltetramethylene diamine, 2-methylocta-methylene diamine, trimethylhexamethylene diamine and mixtures of two or more diamines. Suitable examples of fully aliphatic polyamide polymers include, without limitation, poly(s-caprolactam) PA6; poly(hexamethylene hexanediamide) (PA66); poly(2-methylpentamethylene hexanediamide (PA D6); poly(pentamethylene decadiamide) (PA510); poly(tetramethylene hexanediamide) (PA46); poly(hexamethylene decadiamide) (PA610); poly(hexamethylene dodecanediamide) (PA612); poly(hexamethylene tridecanediamide) (PA613); PA614; poly(hexamethylene pentadecanediamide) (PA615); PA616; poly(l1-aminoundecan-amide) (PA11); poly(l2-aminododecanamide) (PA12); poly(decamethylene decadiamide) (PA1010); and copolymers and mixtures of two or more suitable polyamides.

Preferred aliphatic polyamides include polyamide 6; polyamide 66; polyamide 46; polyamide 610; polyamide 612; polyamide 11; polyamide 12; polyamide 910; polyamide 912; polyamide 913; polyamide 914; polyamide 915; polyamide 616; polyamide 936; polyamide 1010; polyamide 1012; polyamide 1013; polyamide 1014; polyamide 1210; polyamide 1212; polyamide 1213; polyamide 1214; polyamide 614; polyamide 613; polyamide 615; polyamide 616; polyamide 613; and copolymers and combinations of two or more thereof.

Semi-aromatic polyamides are homopolymers, copolymers, terpolymers, or higher polymers in which at least a portion of the acid monomers are selected from one or more aromatic carboxylic acids. The one or more aromatic carboxylic acids can be terephthalic acid or mixtures of terephthalic acid and one or more other carboxylic acids, such as isophthalic acid, substituted phthalic acid such as for example 2-methylterephthalic acid and unsubstituted or substituted isomers of naphthalenedicarboxylic acid. Preferably, the one or more aromatic carboxylic acids are selected from terephthalic acid, isophthalic acid and mixtures thereof. More preferably, the one or more carboxylic acids are mixtures of terephthalic acid and isophthalic acid. Further, the one or more carboxylic acids can be mixed with one or more aliphatic carboxylic acids, such as adipic acid; pimelic acid; suberic acid; azelaic acid; sebacic acid and dodecanedioic acid, adipic acid being preferred. More preferably, the mixture of terephthalic acid and adipic acid in the one or more carboxylic acids mixtures of the semi-aromatic polyamide resin contains at least 25 mole percent of terephthalic acid. Semi-aromatic polyamides further comprise one or more diamines that may be chosen among diamines having four or more carbon atoms, including, but not limited to tetramethylene diamine, hexamethylene diamine, octamethylene diamine, nonamethylene diamine, decamethylene diamine, 2-methylpentamethylene diamine, 2-ethyltetramethylene diamine, 2-methyloctamethylene diamine; trimethylhexamethylene diamine, bis(p-aminocyclohexyl)methane; m-xylylene diamine; p-xylylene diamine and combinations of two or more thereof.

Suitable semi-aromatic polyamides include poly(hexamethylene terephthalamide) (polyamide 6T), poly(nonamethylene terephthalamide) (polyamide 9T), poly(decamethylene terephthalamide) (polyamide 10T), poly(dodecamethylene terephthalamide) (polyamide 12T), hexamethylene terephthalamide/hexamethylene isophthalamide (6T/6I), poly(m-xylylene adipamide) (polyamide MXD6), hexamethylene adipamide/hexamethylene terephthalamide copolyamide (polyamide 66/6T), hexamethylene terephthalamide/2-methylpentamethylene terephthalamide copolyamide (polyamide 6T/DT), hexamethylene adipamide/hexamethylene terephthalamide/hexamethylene isophthalamide copolyamide (polyamide 66/6T/6I); poly(capro lactam-hexamethylene terephthalamide) (polyamide 6/6T) and copolymers and blends of the same. Preferred semi-aromatic polyamide resins comprised in the polyamides described herein include PA6T; PA6T/66; PA6T/6I; PA MXD6; PA6T/DT and copolymers and mixtures thereof.

Preferably, the amount of polymer (a) present in the polymer composition ranges from 20 to 70 weight percent, more preferably from 30 to 65 weight percent, and even more preferably from 40 to 65 weight percent, based on the total weight of components (a), (b), (c), and (d) in the polymer composition.

### Coated Graphite Particle (b)

The coated graphite particle used in the polymer compositions is a graphite particle in which at least a part of the particle's surface is covered by one or more metal compounds. Any known graphite-based particle and its aggregates can be used, such as flake graphite, expandable graphite, expanded graphite, spherical graphite, fiber graphite and mixtures thereof. The graphite may be naturally occurring or synthetic.

The coating on the graphite particle preferably covers or encapsulates from about 50 to 100 percent of the surface of the graphite particle, preferably from about 60 to 100 percent of the surface of the graphite particle, and more preferably from about 70 to 100 percent of the surface of the graphite particle. The percentage of encapsulation or coating of metal compound(s) on the surface of the graphite particles is preferably sufficient to provide in-plane thermal conductivity of an injection-molded article prepared from the polymer compositions disclosed herein, when measured by laser flash method, of at least 2 W/mK, preferably at least 3 W/mK, more preferably at least 4 W/mK. Alternatively, the percentage of encapsulation or coating on the surface of the graphite particles is preferably sufficient to provide the volume resistivity of the article, measured by Hiresta-UP resistivity meters (Mitsubishi Chemical Analytech Co.), is at least 1×10⁹ ohms-centimeters at 23° C. under 500V. More preferably, the in-plane thermal conductivity of the article is at least 2 W/mK and its volume resistivity is at least 1×10⁹ ohms-centimeters at 500V. The percent of encapsulation is not critical so long as the in-plane thermal conductivity of an article prepared from the polymer compositions meets the desired values. If the graphite particles are insufficiently coated, the resulting volume resistivity of articles prepared from these polymer compositions will also be insufficient.

The coated graphite particles can be platy, spherical, fiber- or needle-like in shape before coating the magnesium carbonate onto the graphite. Preferably, the coated graphite particles are platy in shape. When the coated graphite particles are platy, they preferably have a length and width at least 2 times greater than the thickness. Alternatively, the length of coated graphite particles is 2 to 2,000 times longer than its thickness. Length refers to the longest part on the plane surface of a particle, and width refers to the shortest part on the plane surface of a particle. The average size (D50) of the coated graphite particles for length is preferably 0.1 to 500 micrometers, more preferably 1 to 300 micrometers, even more preferably 5 to 150 micrometers, measured by laser diffraction particle size analyzer.

The concentration of coating on the graphite particles may range from about 5 to 50 weight percent, preferably 5 to 40 weight percent, and more preferably 10 to 30 weight percent, based on the total weight of the graphite particle and the coating. The thickness of the coating on the graphite particles may range from about 0.005 to 50 micrometers, preferably 0.01 to 30 micrometers, and more preferably 0.01 to 10 micrometers.

The coating includes one or more metal compounds. Suitable metal compounds have a relatively high volume resistivity, so that the coated graphite particles will be characterized by relatively high thermal conductivity and relatively low electrical conductivity. Preferably, the volume resistivity of the metal compound or combination of metal compounds measured by Hiresta-UP resistivity meters (Mitsubishi Chemical Analytech Co.), is at least 1×10⁹ ohms-centimeters at 23° C. under 500V. It is not expected that the volume resistivity of the coating will differ significantly from that of the bulk metal compound(s).

Suitable metal compounds include, without limitation, carbides, oxides, nitrides, oxycarbides, oxynitrides, selenides, sulfides, carbonates, sulfates, phosphates, silicates, borates, nitrates, and fluorides.

Metal carbonates are preferred metal compounds for coating the graphite particles. Suitable metal carbonates include carbonates of any metal cation. Carbonates of divalent metal cations are preferred, such as for example one or more cations of beryllium, magnesium, calcium, strontium, barium, copper, cadmium, mercury, tin, lead, iron, cobalt, nickel, or zinc. Graphite particles with coatings that comprise, consist essentially of, or consist of magnesium carbonate (MgCO₃) are particularly preferred. The graphite particles coated with MgCO₃ can be obtained by the method described in JP2015044953A, for example.

Preferably, the amount of coated graphite particles (b) in the polymer composition ranges from 5 to 50 weight percent, more preferably from 10 to 45 weight percent, even more preferably from 15 to 40 weight percent, based on the total weight of components (a), (b), (c), and (d) in the polymer composition.

### Inorganic Filler (c)

Suitable inorganic fillers (c) for use in the polymer compositions have an electrical resistivity (p) of at least 1×10⁹ Ω·cm at 1 mm thickness, measured at 23° C. There is no restriction on the type of inorganic filler so long as it meets the criterion for electrical resistivity of at least 1×10⁹ Ω·cm at 1 mm thickness for the pressed particle. Non-limiting examples of suitable inorganic fillers include metal oxides, metal carbonates, carbonate minerals, metal hydroxides, metal nitrides, metal sulfides, phosphate minerals, clay minerals, silicate minerals, glass materials, and combinations of two or more suitable inorganic fillers, whether of the same type, e.g., two metal oxides, or of different types, e.g., a metal oxide and a metal nitride. Examples of suitable metal oxides include aluminum oxide (Al₂O₃), zinc oxide (ZnO), titanium oxide (TiO₂), iron oxide (FeO), magnesium oxide (MgO), silicon oxide (SiO₂), boehmite (Al₂O₃.H₂O) and mixtures thereof. Examples of suitable metal carbonates include calcium carbonate (CaCO₃), and magnesium carbonate (MgCO₃). Examples of suitable carbonate minerals include calcite (polymorph of CaCO₃), aragonite (crystal forms of CaCO₃), dolomite (CaMg(CO₃)₂), hydrotalcite (Mg₆Al₂CO₃(OH)₁₆.4(H₂O)), pyroaurite (Mg₆Fe₂(CO₃)(OH)₁₆.4(H₂O)), stichtite (Mg₆Cr₂CO₃(OH)₁₆.4H₂O), desautelsite (Mg₆Mn₃₊₂(CO₃)(OH)₁₆.4H₂O), and manasseite (Mg₆Al₂(CO₃)(OH)₁₆.4H₂O). Examples of suitable metal hydroxides include aluminum hydroxide (Al(OH)₃), and magnesium hydroxide (Mg(OH)₂. Examples of suitable metal nitrides include boron nitride (BN), aluminum nitride (AlN), and silicon nitride (Si₃N₄). Examples of suitable metal sulfides include molybdenum sulfide (MoS₂), tungsten sulfide (WS₂), and zinc sulfide (ZnS). Examples of suitable phosphate minerals include apatite (Ca₅(PO₄)₃(F,Cl,OH)), and hydroxyapatite (Ca₅(PO₄)₃(OH)). Examples of suitable silicate minerals include serpentine ((Mg,Fe)₃Si₂O₅(OH)₄), pyrophyllite (Al₂Si₄O₁₀(OH)₂), kaolin clay, sericite (KAl₂AlSi₃O₁₀(OH)₂), montmorillonite ((Na,Ca)_{o.33}(A1,Mg)₂Si₄O₁₀(OH)₂.nH₂O), chlorite group of minerals, talc, vermiculite, monoclinic clay-like minerals such as the smectite group of minerals, mica, and diatomite (SiO₂.nH₂O). The chemical formulas shown for many of these examples of inorganic fillers are representative of the group or class of inorganic fillers which can be used in the polymer compositions and in no way limit the inorganic filler to that specific formula.

The inorganic filler(s) used in the polymer composition can be naturally mined or synthesized. Preferred inorganic fillers include talc, mica, clay such as kaolin and bentonite, calcium difluoride, calcium carbonate, silicone, boron nitride, zinc sulfide, and titanium oxide. More preferred inorganic fillers include talc, mica, calcium difluoride, calcium carbonate, zinc sulfide, and titanium oxide.

The inorganic filler(s) (c) in the polymer composition preferably have a platy shape. The platy inorganic filler should have a length and width at least 2 times greater than its thickness. In another word, an aspect ratio of the inorganic filler (the ratio of length or width to thickness) is more than 2. Preferably, the inorganic filler has a length and width at least 5 times greater than its thickness, and more preferably a length and width at least 10 times greater than its thickness. The inorganic fillers have an average length D50 of longest dimension of 100 microns, preferably 70 microns, and more preferably 50 microns.

The total amount of inorganic filler(s) (c) in the polymer composition ranges from about 0.1 to about 40 weight percent, preferably from about 1 to 35 weight percent and more preferably from 3 to 20 weight percent, based on the total weight of components (a), (b), (c), and (d) in the polymer composition. The total weight of components (a), (b), (c), and (d) in the polymer composition equals 100 weight percent.

### Additional Ingredients (d)

The polymer compositions described herein may optionally include additional ingredients such as nucleating agents, flame retardants, flame retardant synergists, heat stabilizers, antioxidants, dyes, mold release agents, lubricants, and UV stabilizers. Examples of nucleating agents include talc and boron nitride. When present, the concentration of additional ingredients (d) will preferably range from about 0.1 to about 20 weight percent, based on the total weight of components (a), (b), (c), and (d) in the polymer composition.

### Preparing the Polymer Composition

The polymer compositions described herein may be prepared using methods known to those skilled in the art, for example, mixing the described ingredients by continuous compounding using a twin-screw extruder. The preferable mixing process consists of the top feeding of polymer(s) and additive(s), and the side feeding of inorganic filler(s).

### Articles

Articles that may be prepared from the polymer compositions described herein include motor housings, lamp housings, lamp sockets and bezels in automobiles and other vehicles as well as electrical and electronic housings. Examples of lamp socket housings include front and rear lights, including headlights, tail lights, and brake lights, particularly those that use light-emitting diode (LED) lamps. The articles may serve as replacements for articles made from aluminum or other metals in many applications.

The articles may be made using methods known to those skilled in the art, such as injection molding, blow molding, or extrusion methods.

Articles comprising the polymer compositions described herein exhibit high thermal conductivity. As used herein, the term “thermal conductivity” refers to the ability of a material to conduct thermal energy. Thermal conductivity can be measured using a molded test sample of 16 mm×16 mm×0.5 mm, formed from the polymer composition. The molded sample for thermal conductivity can be dried under vacuum condition so that the moisture pickup can be less than 0.7% prior to measurement. Thermal conductivity of the molded test sample can be measured in both the in-plane direction and the through-plane direction, using a LFA447 laser flash measurement system (available from NETZSCH Co. of Selb, Germany). The measurement is conducted at 23° C. under moderate moisture less than 50% RH. Thermal conductivity is reported as watts per meter kelvin (W/mK). Articles comprising the polymer compositions disclosed herein exhibit a thermal conductivity of at least 2 W/mK, preferably at least 3 W/mK, more preferably at least 4 W/mK of thermal conductivity measured by in-plane laser flash method at 0.5 mm thickness using LFA447 laser flash measurement system.

Articles comprising the polymer compositions described herein also exhibit desirable electrically insulating properties. Electrically insulating properties can be measured by volume resistivity. As used herein, the term “volume resistivity” refers to the electrical insulating capacity or electrical resistivity of a material. Volume resistivity can be measured using a molded test sample having dimensions of 16 mm×16 mm×1 mm. The molded sample for thermal conductivity can be dried under vacuum condition so that the moisture pickup can be less than 0.7% prior to measurement. Volume resistivity is measured by a Hiresta-UP resistivity meter equipped with a UR-SS probe (available from MITSUBISHI CHEMICAL ANALYTECH, Japan) at 500 Volts [“500V”] for 30 sec along thickness direction. The measurement is conducted at 23° C. under moderate moisture less than 50% RH. This voltage is used to test the electrical resistivity of articles such as LED devices. Volume resistivity is reported as ohms centimeters (Ω·cm). The article of the invention has basically at least 1×10⁸ ohms centimeters at 500V, preferably at least 1×10⁹ ohms-centimeters at 500V, more preferably at least 1×10¹⁰ ohms centimeters at 500V.

Articles can be any thermal management component that requires a desirable combination of thermal conductivity and electrical insulating properties.

The following examples are provided to describe the invention in further detail. These examples, which set forth a preferred mode presently contemplated for carrying out the invention, are intended to illustrate and not to limit the invention.

### EXAMPLES

The raw materials shown in Table 1 were used to prepare the examples (E) and comparative examples (C).

TABLE 1

| Material | | Product names | |
|---|---|---|---|
| Type | Description | and properties | Supplier |
| a-1 | Polyamide 6 | Base resin, RV (relative | Hyosung Co. |
| | | viscosity): 2.7 in sulfuric | |
| | | acid 96%. Relative | |
| | | viscosity of polyamide | |
| | | is determined | |
| | | substantially according | |
| | | to ISO 307: 2007. | |
| b-1 | MgCO₃ coated | Platy shape, D50 is | Kawai Lime |
| | graphite | 60 micrometers | Ind. |
| b-2 | Graphite | Flake graphite, 99.9%, | Qingdao |
| | | platy shape, D50 is | Tianheda |
| | | 60 micrometers | Graphite Co. |
| c-1 | Talc | LMS200, platy shape, | Fuji Talc Ind. |
| | | D50 is 5 micrometers | |
| c-2 | Calcium difluoride | HO-#100, platy shape, | Sankyoseifun |
| | | D50 is 0.2 micrometers | Co. |
| c-3 | Calcium carbonate | MC-35, platy shape, D50 | Komatsu Asahi |
| | | is 25 micrometers | Co. |
| c-4 | Zinc Sulfide | Sachtolith HD-S, | Sachtleben |
| | | indefinite shape, D50 is | Chemie |
| | | 0.2 micrometers | |
| d-1 | Aluminum stearate | AL 103, lubricant and/or | Nitto Kasei Co. |
| | | mold release agent | |
| d-2 | N,N′-hexane-1,6-diylbis[3- | Songnox 1098, | Songwong Ind. |
| | (3,5-di-tert-butyl-4- | antioxidant | |
| | hydroxyphenylpropionamide] | | |

### Test Methods

### Thermal Conductivity (TC)

Thermal diffusivities (a) of the molded test plaques were measured by Laser flash method using LFA447 nanoflash equipment (NETZSCH Co.) at 23° C. The size (length×width×thickness) of molded test plates was 16×16×1 mm. All test plaques were polished to a 0.5 mm thickness and were sprayed with a carbon ointment on the spot where laser was irradiated prior to measurement. For the analysis of heat diffusivity curve, an isotropic/heat loss model was used. Thermal conductivity (λ) of each sample was calculated using the following equation.

λ(W/mK)=α(mm²/s)×Cₚ(J/g·K)×ρ(g/cm³)

Heat capacity (Cₚ) measurements were performed by modulated DSC method with Q2000 differential scanning calorimetry (available from TA Instruments Co. of New Castle, Del., U.S.A.) at 23° C. Sapphire was used as a standard sample for the measurement. Here specific value of sapphire, 0.7708 J/g·K, was adopted as literature value in all measurements.

### Volume Resistivity (VR)

Volume resistivity of the molded plaques obtained above was measured by a Hiresta-UP resistivity meter equipped with a UR-SS probe (available from MITSUBISHI CHEMICAL ANALYTECH, Japan) at 500 Volts [“500V”] for 30 sec along thickness direction. The measurement is conducted at 23° C. under moderate moisture less than 50% RH.

### Melt Flow Rate (MFR)

MFR of the polymer compositions were measured at 280° C. under 2.16 kg loading by a G-01 melt indexer (available from the TOYOSEIKI Co. of Tokyo, Japan). Polymer composition pellet samples were dried at 80° C. for 5 hours under vacuum condition to be less than 0.8% moisture content prior to evaluation.

### Specific Gravity

Specific gravities (ρ) of the samples were measured by Archimedes method with SD-200L gravimeter (Alpha Mirage Co.). Pure water was used as a solvent for the measurement.

### Examples E1 to E7 and Comparative Examples C1 to C3

The materials listed in Table 1 were pre-mixed in the amounts shown in Tables 2 and 3, except for b-1 and b-2. These materials were pre-mixed by continuous compounding (Ikegai PCM 30) at 280° C. at 150 rpm. The thermally conductive fillers, b-1 or b-2, were fed separately into the pre-mixed ingredients at the top position of the extruder. The extrudate was cooled in a water bath and cut into pellets. The obtained pellets were injection molded using a mini-injection molding machine (DSM Xplore) to form molded test plaques (test samples) having the dimensions 16 mm long, 16 mm wide, and 1 mm thick. The pellets were heated to 280° C. for 60 seconds to form a uniform melt mixture which was then extruded at 100° C. into test plaques. Specific gravity, thermal conductivity (in-plane and through-plane), MFR and volume resistivity of these samples were analyzed, and the results are shown in Tables 2 and 3.

TABLE 2

| Ingredients | E1 | E2 | E3 | C1 | C2 | C3 |
|---|---|---|---|---|---|---|
| a-1 | 59.7 | 54.7 | 44.7 | 64.7 | 64.7 | 54.7 |
| b-1 | 35 | 35 | 35 | 35 | — | — |
| b-2 | — | — | — | — | 35 | 35 |
| c-1 | 5 | 10 | 20 | — | — | 10 |
| d-1 | 0.10 | 0.10 | 0.10 | 0.10 | 0.10 | 0.10 |
| d-2 | 0.20 | 0.20 | 0.20 | 0.20 | 0.20 | 0.20 |

Physical Properties

| | | | | | | |
|---|---|---|---|---|---|---|
| Specific | 1.34 | 1.45 | 1.52 | 1.37 | 1.32 | 1.41 |
| gravity | | | | | | |
| In-plane TC | 3.4 | 5.2 | 6.3 | 3.7 | 4.7 | 5.9 |
| (W/mK) | | | | | | |
| Through-plane | 0.43 | 0.50 | 0.50 | 0.45 | 0.52 | 0.51 |
| TC (W/mK) | | | | | | |
| MFR | 23 | 12 | 6 | 26 | 21 | 16 |
| (g/10 min) | | | | | | |
| Volume | >10¹³ | >10¹³ | >10¹³ | 5.5 × 10⁸ | 5.4 × 10⁷ | 8.7 × 10⁷ |
| resistivity | | | | | | |
| (Ω · cm) | | | | | | |

TABLE 3

| Ingredients | E4 | E5 | E6 |
|---|---|---|---|
| a-1 | 54.7 | 54.7 | 54.7 |
| b-1 | 35 | 35 | 35 |
| c-2 | 10 | — | — |
| c-3 | — | 10 | — |
| c-4 | — | — | 10 |
| d-1 | 0.10 | 0.10 | 0.10 |
| d-2 | 0.20 | 0.20 | 0.20 |
| Specific | 1.45 | 1.52 | 1.52 |
| gravity | | | |
| In-plane TC | 5.0 | 6.3 | 6.3 |
| (W/mK) | | | |
| Through-plane | 0.60 | 0.50 | 0.50 |
| TC (W/mK) | | | |
| MFR | 12 | 6 | 6 |
| (g/10 min) | | | |
| Volume | 3.4 × 10¹¹ | 2.2 × 10¹¹ | 3.7 × 10¹⁰ |
| resistivity | | | |
| (Ω · cm) | | | |

Table 2 provides the positive effect of b-1 and its combination with c-1 on the volume resistivity of C1, E1, E2, and E3. The volume resistivity of C1 was higher than that of C2 resulting from the effect of b-1. The property of E2 also proves the b-1/c-1 combination shows the positive impact on the volume resistivity in comparison with C3.

Table 3 shows the morphology effect of synergist filler on the volume resistivity. The platy filler such as c-2 and c-3 led to the higher volume resistivity of E4 and E5 compared with the non-platy filler such as c-4.

While certain of the preferred embodiments of this invention have been described and specifically exemplified above, it is not intended that the invention be limited to such embodiments. Various modifications may be made without departing from the scope and spirit of the invention, as set forth in the following claims.

1. A polymer composition comprising
(a) at least one polymer,
(b) coated graphite particles,
(c) at least one inorganic filler, and optionally
(d) at least one additional ingredient.

2. The polymer composition of claim 1, wherein inorganic filler (c) has an average size (D50) ranging from 0.1 to 100 micrometers when measured by a laser diffraction particle size analyzer.

3. The polymer composition of claim 1, wherein inorganic filler (c) has a platy shape with a length and width which are at least 2 times greater than the thickness of the inorganic filler.

4. The polymer composition of claim 1, wherein inorganic filler (c) is selected from the group consisting of talc, mica, clay, calcium difluoride, calcium carbonate, silicone, zinc sulfide, titanium oxide, and combinations thereof.

5. The polymer composition of claim 1, wherein polymer (a) is selected from the group consisting of polycarbonates, polyolefins, polyarylene sulfides, polyacetals, polyamides, polyesters, and combinations of two or more polycarbonates, polyolefins, polyarylene sulfides, polyacetals, polyamides, and polyesters.

6. The polymer composition of claim 1, wherein polymer (a) comprises a polyamide.

7. The polymer composition of claim 1, wherein the coated graphite particle (b) is coated with at least one metal compound.

8. The polymer composition of claim 1, wherein the at least one metal compound has a volume resistivity of at least 1×109 ohms-centimeters at 23° C. under 500V.

9. The polymer composition of claim 1, wherein the at least one metal compound is selected from the group consisting of carbides, oxides, nitrides, oxycarbides, oxynitrides, selenides, sulfides, carbonates, sulfates, phosphates, silicates, borates, nitrates, and fluorides.

10. The polymer composition of claim 1, wherein the at least one metal compound is a metal carbonate.

11. The polymer composition of claim 1, wherein the at least one metal compound comprises magnesium carbonate.

12. The polymer composition of claim 1, wherein from 50 to 100 percent of the surface of the coated graphite particle (b) is coated with the metal compound.

13. The polymer composition of claim 1, wherein the amount of metal compound coating on the coated graphite particles is from about 5 to 50 weight percent, based on the total weight of the graphite particle and the coating.

14. The polymer composition of claim 1, wherein the thickness of the coating on the coated graphite particles is from about 0.005 to 50 micrometers.

15. The polymer composition of claim 1, wherein the at least one additional ingredient (d) comprises one or more materials selected from the group consisting of nucleating agents, flame retardants, flame retardant synergists, heat stabilizers, antioxidants, dyes, mold release agents, lubricants, and UV stabilizers.

16. The polymer composition of claim 1, wherein the amount of polymer (a) ranges from 20 to 70 weight percent; the amount of coated graphite particles (b) ranges from 5 to 50 weight percent; the amount of inorganic filler(s) (c) ranges from about 0.1 to about 40 weight percent; and when present, the amount of optional additional ingredient(s) (d) ranges from about 0.1 to about 20 weight percent; wherein the weight percentages are based on the total weight of components (a), (b), (c), and (d) in the polymer composition.

17. An article formed from the polymer composition of claim 1.

18. The article of claim 17 that is formed by an injection molding method, a blow molding method, or an extrusion method.

19. The article of claim 17, wherein the in-plane thermal conductivity of the article, when measured by laser flash method, is at least 3 W/mK and the volume resistivity of the article is at least 1×109 ohms-centimeters at 500V.

20. The article of claim 17 that is a motor housing, a lamp housing, a vehicle lamp socket or bezel, or an electrical or electronic housing.
